(19) United States
(12) Patent Application Publication
(10) Pub. No.: US 2025/0084221 A1
(43) Pub. Date: Mar. 13, 2025

(54) MASTERBATCH, RUBBER COMPOSITION FOR TIRE, TIRE, AND MANUFACTURING METHODS THEREOF

(71) Applicant: Toyo Tire Corporation, Itami-shi (JP)

(72) Inventor: Keisuke Mogari, Itami-shi (JP)

(73) Assignee: Toyo Tire Corporation, Itami-shi (JP)

(21) Appl. No.: 18/788,381

(22) Filed: Jul. 30, 2024

(30) Foreign Application Priority Data
Sep. 8, 2023 (JP) 2023-145832

(51) Int. Cl. C08J 3/22; B60C 1/00; C08K 3/36; C08K 7/02; C08L 7/02

(52) U.S. Cl. CPC C08J 3/22; B60C 1/0041; C08K 3/36; C08K 7/02; C08L 7/02; C08J 2307/02; C08J 2401/02; C08K 2201/003; C08K 2201/005

(57) ABSTRACT

A masterbatch manufacturing method includes an operation in which at least a cellulose nanofiber dispersion, colloidal silica, and diene-based rubber latex are mixed to prepare a liquid mixture; and an operation in which the liquid mixture is coagulated.

### BACKGROUND OF THE INVENTION

### Field of the Invention

The present invention relates to a masterbatch, a rubber composition for tire, a tire, and manufacturing methods thereof.

### Description of the Related Art

Cellulose fibers can be extracted from a wide variety of biomass and has little environmental impact, and a wide variety of research and development related to utilization of cellulose fibers, including utilization of cellulose fibers in pneumatic tires, are currently underway (see, for example, Patent Documents 1 through 3).

Meanwhile, it is known to use silica, namely, white carbon, as a filler in pneumatic tires. In pneumatic tires, wet silica is usually used, taking into consideration the balance between cost and performance.

Meanwhile, improvements in various kinds of performance, such as ability to achieve reduced fuel consumption and cutting resistance, are demanded of pneumatic tires. In order to improve the ability to achieve reduced fuel consumption of pneumatic tires, it is effective to improve the ability to achieve reduced heat generation of rubber. In order to improve the cutting resistance of pneumatic tires, it is effective to improve the tearing strength of rubber.

### PRIOR ART DOCUMENT

### Patent Documents

Patent Document 1: JP-A-2006-206864

Patent Document 2: JP-A-2009-191198

Patent Document 3: JP-A-2020-55962

### SUMMARY OF THE INVENTION

It is an object of the present invention to provide a method for manufacturing a masterbatch to be a raw material for vulcanized rubber excellent in the ability to achieve reduced heat generation and tearing strength (namely, cutting resistance). In addition to this, it is an object of the present invention to provide a method for manufacturing a rubber composition to be a raw material for a tire excellent in the ability to achieve reduced fuel consumption and tearing strength (namely, cutting resistance). It is also an object of the present invention to provide a method for manufacturing a tire excellent in the ability to achieve reduced fuel consumption and tearing strength (namely, cutting resistance).

A masterbatch manufacturing method of the present invention includes: an operation in which at least a cellulose nanofiber dispersion, colloidal silica, and diene-based rubber latex are mixed to prepare a liquid mixture; and an operation in which the liquid mixture is coagulated.

The masterbatch manufacturing method of the present invention adopts a procedure in which a cellulose nanofiber dispersion and diene-based rubber latex are mixed and the liquid mixture is coagulated, and it is thus possible to disperse cellulose nanofibers to a higher degree compared to the case where cellulose nanofibers are dried and then mixed with diene-based rubber latex.

Furthermore, since colloidal silica is mixed with the cellulose nanofiber dispersion and the diene-based rubber latex, the dispersibility of silica particles can be improved. This will be explained. Colloidal silica is a dispersion of silica particles. The silica particles in colloidal silica are dispersed individually, that is, without agglomeration. According to the masterbatch manufacturing method of the present invention, since the cellulose nanofiber dispersion and diene-based rubber latex are mixed with colloidal silica and the liquid mixture is then coagulated, that is, rubber particles, cellulose nanofibers, and non-agglomerated silica particles are coagulated, it is possible to intercalate not only rubber particles but also cellulose nanofibers between the silica particles. Therefore, the agglomeration of silica particles can be reduced. In other words, the dispersibility of silica particles can be improved.

Consequently, according to the masterbatch manufacturing method of the present invention, it is possible to improve the ability to achieve reduced heat generation and tearing strength (namely, cutting resistance) of vulcanized rubber.

The colloidal silica preferably has a particle size of 2 nm to 40 nm.

In the operation in which a liquid mixture is prepared, silica particles in the colloidal silica are preferably 1 part by mass or more and 30 parts by mass or less per 100 parts by mass of the dry rubber component in the diene-based rubber latex.

The fiber diameter of cellulose nanofibers in the cellulose nanofiber dispersion is preferably 100 nm or less.

In the operation in which a liquid mixture is prepared, cellulose nanofibers in the cellulose nanofiber dispersion are 1 part by mass or more and 50 parts by mass or less per 100 parts by mass of the dry rubber component in the diene-based rubber latex.

The diene-based rubber latex is preferably natural rubber latex.

A method for manufacturing a rubber composition for tire of the present invention includes: an operation in which a masterbatch is prepared by the manufacturing method described above; and an operation in which the masterbatch is used to prepare a rubber composition.

A tire manufacturing method of the present invention includes: an operation in which a masterbatch is prepared by the manufacturing method described above; an operation in which the masterbatch is used to prepare a rubber composition; and an operation in which the rubber composition is used to prepare an unvulcanized tire.

### DETAILED DESCRIPTION OF THE PREFERRED EMBODIMENTS

Below, description is given with respect to embodiments of the present invention.

### 1. Masterbatch Manufacturing Method

A masterbatch manufacturing method of the present embodiment includes an operation (hereinafter sometimes referred to as “Operation A”) in which at least a cellulose nanofiber dispersion, colloidal silica, and diene-based rubber latex are mixed to prepare a liquid mixture, and an operation (hereinafter sometimes referred to as “Operation B”) in which the liquid mixture is coagulated. The masterbatch manufacturing method of the present embodiment includes Operation A and Operation B, and it is thus possible to improve the ability to achieve reduced heat generation and tearing strength (namely, cutting resistance) of vulcanized rubber. The masterbatch manufacturing method of the present embodiment may further include an operation (hereinafter sometimes referred to as “Operation C”) in which the coagulum is dewatered, if necessary.

### 1.1. Operation A (Operation in Which Liquid Mixture is Prepared)

In Operation A, at least a cellulose nanofiber dispersion, colloidal silica, and diene-based rubber latex are mixed to prepare a liquid mixture. During such mixing, a disperser, for example, a high-shear mixer, homomixer, ball mill, bead mill, high-pressure homogenizer, ultrasonic homogenizer, colloid mill, and/or the like may be used.

The cellulose nanofiber dispersion may contain cellulose nanofibers and water. In the cellulose nanofiber dispersion, cellulose nanofibers may be dispersed in water. If necessary, the cellulose nanofiber dispersion may contain other additives, for example, organic solvents, surface active agents, and dispersants. Examples of the dispersants include an acrylic dispersant and an acrylamide-based dispersant. The cellulose nanofiber dispersion preferably does not contain a dispersant. This makes it possible to reduce the cost.

As cellulose nanofiber raw materials, wood, rice husks, straw, bamboo, and so forth may be cited as examples. Where the raw material is pulp, a method which includes a procedure by which the pulp, after being subjected to chemical treatment and/or enzymatic treatment, is fibrillated in water might, for example, be used to obtain cellulose nanofiber. A method which includes a procedure by which pulp that has not been subjected to chemical treatment or enzymatic treatment is mechanically fibrillated in water may also be used to obtain cellulose nanofiber.

In a case where the cellulose nanofibers are prepared by a method including an operation in which pulp is mechanically defibrated in water, the operation is preferably an operation in which pulp is defibrated by the collision of at least two pulp-containing liquid streams. This makes it possible to further improve the rigidity of vulcanized rubber. It is considered that this is because pulp is defibrated by the collision of these liquid streams, this can prevent excessive crushing, and as a result, the decrease in the reinforcing action of cellulose nanofibers that may occur by excessive crushing can be suppressed. Examples of the cellulose nanofibers prepared by such an operation includes “WFo-10002” manufactured by Sugino Machine Limited (the cellulose nanofiber product used in Working Examples described later). The number of liquid streams may be two, three, or four or more. Incidentally, before or after the collision, that is, the collision of at least two liquid streams, another liquid stream may further collide with the two liquid streams. This other liquid stream may be a pulp-containing liquid stream or a pulp-free liquid stream.

The fiber diameter of cellulose nanofibers is preferably less than 1000 nm, more preferably 300 nm or less, still more preferably 100 nm or less, still more preferably 70 nm or less. The fiber diameter of cellulose nanofibers may be, for example, 2 nm or more, or 10 nm or more. The fiber diameter of cellulose nanofibers may be the arithmetic mean of fiber diameters of ten randomly selected cellulose nanofibers. The fiber diameter of cellulose nanofibers may be measured using a field emission scanning electron microscope, namely FE-SEM. For example, the fiber diameter may be measured by the following method.

### Method for Measuring Fiber Diameter of Cellulose Nanofiber

The cellulose nanofiber dispersion is diluted with distilled water. The diluted solution is dropped onto the grid and dried, and the cellulose nanofibers are observed using a field emission scanning electron microscope, namely FE-SEM, under the following conditions.
Magnification for observation 2000×
Working distance WD=2 mm
Detector InLens
Electron beam accelerating voltage 1 kV

The diameter of cellulose nanofibers appearing in the FE-SEM image is measured.

The fiber length of cellulose nanofibers is preferably 40 μm or less, more preferably 20 μm or less, still more preferably 10 μm or less. As the fiber length is 40 μm or less, it is possible to prevent the viscosity of the cellulose nanofiber dispersion or liquid mixture from becoming excessively high, and thus the cellulose nanofibers may be dispersed to a higher degree. The fiber length of cellulose nanofibers may be, for example, 0.1 μm or more, 1 μm or more, or 2 μm or more. Here, the “fiber length” refers to the length of at least one fiber in the cellulose nanofiber dispersion. The fiber length of cellulose nanofibers can also be measured using a field emission scanning electron microscope, namely FE-SEM. For example, the measurement may be performed using FE-SEM images captured under the observation conditions described above.

In colloidal silica, silica particles are dispersed in a dispersion medium, for example, water, an alcohol-based solvent, or a liquid mixture thereof. Among these, silica particles are preferably dispersed in water. The silica particles in colloidal silica may be dispersed individually, that is, without agglomeration.

The particle size of colloidal silica, that is, the particle size of silica particles in the colloidal silica, is preferably 40 nm or less, more preferably 30 nm or less, still more preferably 20 nm or less. When the particle size is 40 nm or less, the ability to achieve reduced heat generation and tearing strength of vulcanized rubber can be further improved. The particle size of colloidal silica may be, for example, 2 nm or more, 4 nm or more, or 6 nm or more. The particle size of colloidal silica may be calculated based on the specific surface area and density determined by the Sears method or the BET method.

The diene-based rubber latex is rubber latex containing diene-based rubber particles (hereinafter, sometimes simply referred to as “rubber particles”). In the diene-based rubber latex, the diene-based rubber particles may be dispersed in the dispersion medium in a colloidal state. Specifically, in the diene-based rubber latex, diene-based rubber particles may be dispersed in water in a colloidal state. The diene-based rubber latex may contain an organic solvent. In other words, in a case where the dispersion medium is water, the dispersion medium may contain an organic solvent. The diene-based rubber may have unsaturated hydrocarbon bonds, preferably carbon-carbon double bonds in the main chain.

Examples of the diene-based rubber latex include natural rubber latex and synthetic rubber latex. Among these, natural rubber latex is preferred.

As natural rubber latex, concentrated natural rubber latex and field latex may be cited as examples. In the natural rubber latex, rubber particles may be dispersed in colloidal fashion in dispersion medium. More specifically, in the natural rubber latex, rubber particles may be dispersed in colloidal fashion in water. The natural rubber latex may contain organic solvent. In other words, in a case where the dispersion medium is water, the dispersion medium may contain an organic solvent.

It is preferred that dry rubber content of the natural rubber latex be not less than 10% by mass, and more preferred that this be not less than 20% by mass. The upper limit of the range in values for the dry rubber content of the natural rubber latex might, for example, be 60% by mass or 50% by mass.

A carbon black slurry may be mixed with the cellulose nanofiber dispersion, colloidal silica, and diene-based rubber latex.

The carbon black slurry may contain carbon black and water. In the carbon black slurry, carbon black may be dispersed in water. The carbon black slurry may be obtained by adding carbon black to water and subjecting this to agitation. During agitation, a disperser, for example, a high-shear mixer, homomixer, ball mill, bead mill, high-pressure homogenizer, ultrasonic homogenizer, colloid mill, and/or the like, may be used. Where necessary, the carbon black slurry may contain any of various other additives, for example, organic solvents and surface active agents.

As examples of carbon black, besides SAF, ISAF, HAF, FEF, GPF, and/or other such furnace blacks, acetylene black, Ketchen black, and/or other such electrically conductive carbon blacks may be used. The carbon black may be nongranulated carbon black or may be granulated carbon black that has been granulated based upon considerations related to the handling characteristics thereof. Any one thereamong may be used, or any two or more thereamong may be used.

Regarding the liquid mixture, the amount of cellulose nanofibers (specifically, cellulose nanofibers from the cellulose nanofiber dispersion) is preferably 1 part by mass or more, more preferably 3 parts by mass or more, still more preferably 5 parts by mass or more per 100 parts by mass of the dry rubber component in the diene-based rubber latex. The amount of cellulose nanofibers may be, for example, 50 parts by mass or less, 30 parts by mass or less, 20 parts by mass or less, or 15 parts by mass or less per 100 parts by mass of the dry rubber component in the diene-based rubber latex.

Regarding the liquid mixture, the amount of silica particles (specifically, silica particles from colloidal silica) is preferably 1 part by mass or more, more preferably 3 parts by mass or more, still more preferably 5 parts by mass or more per 100 parts by mass of the dry rubber component in the diene-based rubber latex. The amount of silica particles may be, for example, 30 parts by mass or less, 20 parts by mass or less, or 15 parts by mass or less per 100 parts by mass of the dry rubber component in the diene-based rubber latex.

Regarding the liquid mixture, with regard to the mass of cellulose nanofibers from the cellulose nanofiber dispersion (hereinafter sometimes referred to as “Mass M_{C}”) and the mass of silica particles from colloidal silica (hereinafter sometimes referred to as “Mass M_{S}”), Mass M_{C} may be, for example, 5% or more, 10% or more, or 20% or more when the sum of Mass M_{C} and Mass M_{S} is 100%. Mass M_{C}may be, for example, 80% or less, 60% or less, 40% or less, or 30% or less.

### 1.2. Operation B (Operation in Which Liquid Mixture is Coagulated)

In Operation B, the liquid mixture is coagulated. In other words, the rubber particles, cellulose nanofibers, and silica particles in the liquid mixture are coagulated. In a case where the liquid mixture contains carbon black, carbon black may also be coagulated with these. In order to coagulate the liquid mixture, the liquid mixture may be dried by heating or pulse-dried, or a coagulant may be added to the liquid mixture. From the viewpoint of time and labor and man-hours, drying by heating or addition of a coagulant is preferred. An example of the coagulant may be an acid. As the acid, formic acid, sulfuric acid, and the like may be cited as examples. Addition of coagulant may be carried out while agitating the liquid mixture, may be carried out while heating the liquid mixture, or may be carried out in state(s) constituting any desired combination thereof (that is, agitation and/or heating).

Following coagulation, the coagulum may be separated from waste liquid as necessary. The coagulum might, for example, take the form of small pieces. Note that coagulum in the form of small pieces is sometimes referred to as “crumbs”. A filter might, for example, be employed to separate coagulum from waste liquid.

### 1.3. Operation C (Operation in Which Coagulum is Dewatered)

The coagulum is dewatered if necessary. An extruder, oven, vacuum dryer, and/or air dryer might, for example, be used to dewater the coagulum. Of these, an extruder is preferred. Use of an extruder will make it possible to dewater the coagulum through compaction and/or other effects, and will make it possible to cause the dewatered coagulum to be plasticized as it is dried. As the extruder, a single-screw extruder may be cited as an example.

### 1.4. Other Operations

The extruded coagulum, that is, the dewatered coagulum, may be cut if necessary, and may be compressed and formed into any desired shape (for example, into bales) as necessary. A pelletizer might, for example, be used to carry out cutting.

The masterbatch thus obtained may take the form of bales. The form taken by the masterbatch is not limited to bales, it being possible for this to take the form of pellets, to take the form of rods, or to take the form of sheets.

The masterbatch contains a rubber component including diene-based rubber. In 100% by mass of the rubber component in the masterbatch, the amount of diene-based rubber may be, for example, 80% by mass or more, 90% by mass or more, or 100% by mass.

In the masterbatch, the amount of natural rubber in 100% by mass of diene-based rubber is preferably 80% by mass or more, more preferably 90% by mass or more, still more preferably 95% by mass or more, still more preferably 100% by mass.

The masterbatch contains cellulose nanofibers. The amount of cellulose nanofibers is preferably 1 part by mass or more, more preferably 3 parts by mass or more, still more preferably 5 parts by mass or more per 100 parts by mass of the rubber component. The amount of cellulose nanofibers may be, for example, 50 parts by mass or less, 30 parts by mass or less, 20 parts by mass or less, or 15 parts by mass or less.

The masterbatch contains silica particles. The amount of silica particles is preferably 1 part by mass or more, more preferably 3 parts by mass or more, still more preferably 5 parts by mass or more per 100 parts by mass of the rubber component. The amount of silica particles may be, for example, 30 parts by mass or less, 20 parts by mass or less, or 15 parts by mass or less.

The masterbatch may further contain a compounding ingredient, for example, carbon black. The amount of carbon black is preferably 1 part by mass or more, more preferably 3 parts by mass or more, still more preferably 5 parts by mass or more per 100 parts by mass of the rubber component. The amount of carbon black may be, for example, 50 parts by mass or less, 30 parts by mass or less, or 20 parts by mass or less.

### 2. Tire Manufacturing Method

A tire manufacturing method of the present embodiment includes an operation in which masterbatch is prepared in the method described above, an operation in which the masterbatch is used to prepare a rubber composition, and an operation in which the rubber composition is used to prepare an unvulcanized tire.

### 2.1. Operation in Which Masterbatch is Used to Prepare Rubber Composition

This operation (more specifically, an operation in which masterbatch is used to prepare a rubber composition) may include kneading at least masterbatch and compounding ingredient(s) to prepare a rubber mixture, and kneading at least the rubber mixture and vulcanizing-type compounding ingredient(s) to obtain a rubber composition.

At this operation, at least masterbatch and compounding ingredient(s) are kneaded to prepare a rubber mixture. As compounding ingredient(s), filler, zinc oxide, stearic acid, wax, antioxidant, silane coupling agent, vulcanizing-type compounding ingredient, and the like may be cited as examples. One or any desired combination may be chosen from thereamong and used as compounding ingredient(s). Note, however, that it is preferred that vulcanizing-type compounding ingredient not be added at this stage. As filler, carbon black, silica, clay, talc, calcium carbonate, magnesium carbonate, aluminum hydroxide, and the like may be cited as examples. One or any desired combination may be chosen from thereamong and used as the filler. Where carbon black is added at this stage, the properties of such carbon black may be the same as or may be different from the properties of carbon black used in the carbon black slurry. For example, the grade of any carbon black which may be added at this stage may be the same as or may be different from the grade of carbon black used in the carbon black slurry, as defined by ASTM (American Society for Testing and Materials). As antioxidant, aromatic-amine-type antioxidant, amine-ketone-type antioxidant, monophenol-type antioxidant, bisphenol-type antioxidant, polyphenol-type antioxidant, dithiocarbamate-type antioxidant, thiourea-type antioxidant, and the like may be cited as examples. One or any desired combination may be chosen from thereamong and used as the antioxidant. Other rubber(s) may be kneaded therein together with the masterbatch and compounding ingredient(s). As such rubber, natural rubber, polyisoprene rubber, butadiene rubber, styrene-butadiene rubber, nitrile rubber, chloroprene rubber, and the like may be cited as examples. One or any desired combination may be chosen from thereamong and used. Kneading may be carried out using a kneader. As the kneader, internal kneaders, open roll mills, and the like may be cited as examples. As an internal kneader, Banbury mixers, kneaders, and the like may be cited as examples.

At this operation, at least the rubber mixture and vulcanizing-type compounding ingredient(s) are kneaded to obtain a rubber composition. As vulcanizing-type compounding ingredients, sulfur, organic peroxides, and other such vulcanizing agents, vulcanization accelerators, vulcanization accelerator activators, vulcanization retarders, and so forth may be cited as examples. One or any desired combination may be chosen from thereamong and used as the vulcanizing-type compounding ingredient. As sulfur, powdered sulfur, precipitated sulfur, insoluble sulfur, high dispersing sulfur, and the like may be cited as examples. One or any desired combination may be chosen from thereamong and used as the sulfur. As vulcanization accelerators, sulfenamide-type vulcanization accelerators, thiuram-type vulcanization accelerators, thiazole-type vulcanization accelerators, thiourea-type vulcanization accelerators, guanidine-type vulcanization accelerators, dithiocarbamate-type vulcanization accelerators, and so forth may be cited as examples. One or any desired combination may be chosen from thereamong and used as the vulcanization accelerator. Kneading may be carried out using a kneader. As the kneader, internal kneaders, open roll mills, and the like may be cited as examples. As an internal kneader, Banbury mixers, kneaders, and the like may be cited as examples.

The rubber composition contains a rubber component derived from the masterbatch. The amount of the rubber component derived from the masterbatch may be, for example, 20% by mass or more, 40% by mass or more, 60% by mass or more, 80% by mass or more, or 100% by mass per 100% by mass of the rubber component in the rubber composition.

In 100% by mass of the rubber component in the rubber composition, the amount of natural rubber is preferably 40% by mass or more, more preferably 60% by mass or more, still more preferably 70% by mass or more. The amount of natural rubber may be 80% by mass or more, 90% by mass or more, or 100% by mass.

In 100% by mass of the rubber component in the rubber composition, the amount of butadiene rubber may be, for example, 5% by mass or more, 10% by mass or more, or 20% by mass or more. The amount of butadiene rubber may be, for example, 60% by mass or less, 40% by mass or less, or 30% by mass or less.

The rubber composition contains cellulose nanofibers. The amount of cellulose nanofibers is preferably 1 part by mass or more, more preferably 3 parts by mass or more, still more preferably 5 parts by mass or more per 100 parts by mass of the rubber component in the rubber composition. The amount of cellulose nanofibers may be, for example, 50 parts by mass or less, 30 parts by mass or less, 20 parts by mass or less, or 15 parts by mass or less.

The rubber composition contains silica particles. The amount of silica particles is preferably 1 part by mass or more, more preferably 3 parts by mass or more, still more preferably 5 parts by mass or more per 100 parts by mass of the rubber component in the rubber composition. The amount of silica particles may be, for example, 30 parts by mass or less, 20 parts by mass or less, or 15 parts by mass or less.

The rubber composition may contain carbon black. The amount of carbon black is preferably 1 part by mass or more, more preferably 3 parts by mass or more, still more preferably 5 parts by mass or more per 100 parts by mass of the rubber component in the rubber composition. The amount of carbon black may be, for example, 50 parts by mass or less, 30 parts by mass or less, or 20 parts by mass or less.

The total amount of cellulose nanofibers, silica particles, and carbon black is preferably 6 parts by mass or more, more preferably 15 parts by mass or more, still more preferably 20 parts by mass or more per 100 parts by mass of the rubber component in the rubber composition. This total amount may be, for example, 80 parts by mass or less, 50 parts by mass or less, or 40 parts by mass or less.

The rubber composition may further contain zinc oxide, stearic acid, wax, an antioxidant, a silane coupling agent, sulfur, a vulcanization accelerator, and/or the like. The rubber composition may contain one or any desired combination thereamong. The amount of sulfur, expressed as equivalent sulfur content, is preferably 0.5 part by mass to 5 parts by mass per 100 parts by mass of the rubber component in the rubber composition. The amount of the vulcanization accelerator is preferably 0.1 part by mass to 5 parts by mass per 100 parts by mass of the rubber component in the rubber composition.

The rubber composition may be used to prepare a tire. More specifically, it is capable of being used in preparing tire member(s) making up a tire. For example, the rubber composition may be used in preparing tread rubber, sidewall rubber, chafer rubber, bead filler rubber, and/or the like. The rubber composition may be used to prepare one or any desired combination among such tire member(s).

### 2.2. Operation in Which Rubber Composition is Used to Prepare Unvulcanized Tire

A tire manufacturing method of the present embodiment includes an operation in which a rubber composition is used to prepare an unvulcanized tire. This operation may include preparing tire member(s) containing a rubber composition, and preparing an unvulcanized tire containing the tire member(s). As tire members, tread rubber, sidewall rubber, chafer rubber, and bead filler rubber may be cited as examples. Among these, sidewall rubber is preferable.

### 2.3. Other Operations

A tire manufacturing method of the present embodiment may further include an operation in which the unvulcanized tire is vulcanized and molded. The tire obtained by the method of the present embodiment may be a pneumatic tire.

### 3. Various Modifications May Be Made to the Foregoing Embodiment

Various modifications may be made to the foregoing embodiment. For example, modifications which may be made to the foregoing embodiment might include any one or more variations chosen from among the following.

The foregoing embodiment was described in terms of a constitution in which water is used to prepare a carbon black slurry. However, the foregoing embodiment is not limited to this constitution. For example, dilute rubber latex may be used instead of water. More specifically, a carbon black slurry might be prepared through employment of a procedure in which carbon black is added to dilute rubber latex, and this is agitated. In the dilute rubber latex, rubber particles may be dispersed in colloidal fashion in water. The water might, for example, be water that contains organic solvent. It is preferred that dry rubber content of the dilute rubber latex be not less than 0.1% by mass, and more preferred that this be not less than 0.3% by mass. It is preferred that the upper limit of the range in values for the dry rubber content be 5% by mass, and more preferred that this be 2% by mass. The dilute rubber latex might, for example, be prepared through employment of a procedure in which natural rubber latex is diluted with water. Synthetic rubber latex may be used instead of natural rubber latex.

The foregoing embodiment was described in terms of a constitution in which masterbatch and compounding ingredient(s) are kneaded to prepare a rubber mixture. However, the foregoing embodiment is not limited to this constitution. For example, the rubber mixture may be treated as a masterbatch.

The foregoing embodiment was described in terms of a constitution in which the tire is a pneumatic tire. However, the foregoing embodiment is not limited to this constitution.

### Working Examples

Working Examples of the present invention are described below.

The raw materials and reagents that were used at the Working Examples are indicated below.
Natural rubber latex “NR Field Latex” manufactured by Golden Hope Plantations Berhad
Solid natural rubber Solid rubber prepared by drying “NR Field Latex” manufactured by Golden Hope Plantations Berhad
Butadiene rubber “BR150B” manufactured by UBE Corporation
CNF1 “WFo-10002” manufactured by Sugino Machine Limited, aqueous dispersion of cellulose nanofibers having fiber diameter of 10 to 50 nm and fiber length of 1 to 9 μm (fiber diameter and fiber length are catalog values)
CNF2 “Ultra-Long Product” manufactured by Sugino Machine Limited, aqueous dispersion of cellulose nanofibers having fiber diameter of 10 to 60 nm and fiber length of 5 to 9 μm (fiber diameter and fiber length are catalog values)
Wet silica “Ultrasil VN3” manufactured by EVONIK
Colloidal silica 1 “SNOWTEX (registered trademark) XS” manufactured by Nissan Chemical Corporation (aqueous dispersion of silica particles having size of 4 to 6 nm)
Colloidal silica 2 “SNOWTEX (registered trademark) 30” manufactured by Nissan Chemical Corporation (aqueous dispersion of silica particles having size of 10 to 15 nm)
Carbon black “DIABLACK A” manufactured by Mitsubishi Chemical Corporation
Zinc oxide “Zinc Oxide Variety No. 2” manufactured by Mitsui Mining & Smelting Co., Ltd.
Stearic acid “Stearic acid” manufactured by NOF Corporation
Antioxidant “Santoflex 6PPD” manufactured by FLEXSYS
Sulfur “OIL TREATED SULFUR POWDER 150 mesh” manufactured by Tsurumi Chemical Industry Co., ltd.
Vulcanization accelerator “Sanceler NS-G” manufactured by SANSHIN CHEMICAL INDUSTRY CO., LTD.

### Preparation of Masterbatch in Working Examples 1 to 9

Natural rubber latex and colloidal silica were added to the cellulose nanofiber dispersion according to the blended amounts shown in TABLE 1, and this was agitated for 30 minutes at 1000 rpm in a mixer (“SM-20 Supermixer” manufactured by Kawata Co., Ltd.) to obtain a liquid mixture. The liquid mixture was placed in an oven and was dried overnight at 70° C. Masterbatch was obtained as a result of such procedure.

### Preparation of Masterbatch in Comparative Example 3

Natural rubber latex and wet silica were added to the cellulose nanofiber dispersion according to the blended amounts shown in TABLE 1, and this was agitated for 30 minutes at 1000 rpm in a mixer (“SM-20 Supermixer” manufactured by Kawata Co., Ltd.) to obtain a liquid mixture. The liquid mixture was placed in an oven and was dried overnight at 70° C. Masterbatch was obtained as a result of such procedure.

### Preparation of Masterbatches in Comparative Examples 4 and 5

Colloidal silica was added to natural rubber latex according to the blended amount shown in TABLE 1, and this was agitated for 30 minutes at 1000 rpm in a mixer (“SM-20 Supermixer” manufactured by Kawata Co., Ltd.) to obtain a liquid mixture. The liquid mixture was placed in an oven and was dried overnight at 70° C. Masterbatch was obtained as a result of such procedure.

### Preparation of Masterbatches in Comparative Examples 6 and 7

Natural rubber latex was added to the cellulose nanofiber dispersion according to the blended amount shown in TABLE 1, and this was agitated for 30 minutes at 1000 rpm in a mixer (“SM-20 Supermixer” manufactured by Kawata Co., Ltd.) to obtain a liquid mixture. The liquid mixture was placed in an oven and was dried overnight at 70° C. Masterbatch was obtained as a result of such procedure.

### Preparation of Unvulcanized Rubber in Working Examples 1 to 9 and Comparative Examples 3 to 7

The compounding ingredient except for sulfur and the vulcanization accelerator was added to the masterbatch according to TABLE 1, and kneading was performed using a Banbury mixer to obtain a rubber mixture. The rubber mixture was kneaded with sulfur and vulcanization accelerator using a Banbury mixer to obtain unvulcanized rubber.

### Preparation of Unvulcanized Rubber in Comparative Examples 1 and 2

The compounding ingredient except for sulfur and the vulcanization accelerator was added to solid natural rubber according to TABLE 1, and kneading was performed using a Banbury mixer to obtain a rubber mixture. The rubber mixture was kneaded with sulfur and vulcanization accelerator using a Banbury mixer to obtain unvulcanized rubber.

In Comparative Examples 1 and 2, the cellulose nanofiber dispersion was dried and then added to solid natural rubber (that is, dry cellulose nanofiber powder was added to solid natural rubber). In Comparative Example 2, colloidal silica was dried and then added to solid natural rubber.

### Preparation of Vulcanized Rubber in Respective Examples

The unvulcanized rubber was vulcanized for 30 minutes at 150° C. to obtain vulcanized rubber.

### Cutting Resistance

The tearing strength was measured in conformity with JIS K6252-1:2015. Specifically, a crescent-shaped test piece, specifically, a crescent-shaped test piece in which a 0.50±0.08 mm notch was made in the center of the depression, was prepared using vulcanized rubber, and pulled at a tensile speed of 500 mm/min using a tensile testing machine manufactured by Shimadzu Corporation until the crescent-shaped test piece broke. The maximum force required to tear the crescent-shaped test piece was divided by the thickness of the crescent-shaped test piece. The tearing strength was thus determined. The tearing strength of the respective Examples is shown in TABLE 1 as indexed relative to a value of 100 for the tearing strength of Comparative Example 1. The larger the index, the greater the tearing strength and the superior the cutting resistance.

### Exothermicity

tan δ of the vulcanized rubber was measured using a viscoelasticity tester manufactured by Toyo Seiki Seisaku-sho, Ltd. As the measurement conditions, the static strain was 10%, the dynamic strain was ±2%, the frequency was 50 Hz, and the temperature was 60° C. tan δ of the respective Examples is shown in TABLE 1 as indexed relative to a value of 100 for the tan δ of Comparative Example 1. As the index is smaller, tan δ is lower, heat is less likely to be generated, and thus the ability to achieve reduced fuel consumption is superior.

TABLE 1

| | | | | | | | | | | Working |
|---|---|---|---|---|---|---|---|---|---|---|
| | | | Comparative Examples | | | | | | | Examples |
| | | | 1 | 2 | 3 | 4 | 5 | 6 | 7 | 1 |
| Masterbatch | Parts | Natural rubber latex | — | — | 100 | 100 | 100 | 100 | 70 | 100 |
| | by mass | (dry rubber component) | | | | | | | | |
| | | CNF1 | — | — | 5 | — | — | 5 | 5 | 5 |
| | | CNF2 | — | — | — | — | — | — | — | — |
| | | Wet silica | — | — | 10 | — | — | — | — | — |
| | | Colloidal silica 1 | — | — | — | — | — | — | — | 10 |
| | | Colloidal silica 2 | — | — | — | 10 | 10 | — | — | — |
| Rubber | Parts | Masterbatch | — | — | 115 | 110 | 110 | 105 | 75 | 115 |
| composition | by mass | Solid natural rubber | 100 | 100 | — | — | — | — | — | — |
| | | CNF1 | 5 | 5 | — | — | 5 | — | — | — |
| | | Wet silica | 10 | — | — | — | — | — | 10 | — |
| | | Colloidal silica 2 | — | 10 | — | — | — | 10 | — | — |
| | | Carbon black | 5 | 5 | 5 | 5 | 5 | 5 | 5 | 5 |
| | | Butadiene rubber | — | — | — | — | — | — | 30 | — |
| | | Zinc oxide | 1 | 1 | 1 | 1 | 1 | 1 | 1 | 1 |
| | | Stearic acid | 2 | 2 | 2 | 2 | 2 | 2 | 2 | 2 |
| | | Antioxidant | 2 | 2 | 2 | 2 | 2 | 2 | 2 | 2 |
| | | Sulfur | 2 | 2 | 2 | 2 | 2 | 2 | 2 | 2 |
| | | Vulcanization accelerator | 1 | 1 | 1 | 1 | 1 | 1 | 1 | 1 |
| | Mass ratio of cellulose nanofiber to silica | | — | 1:2 | 1:2 | 1:2 | 1:2 | 1:2 | 1:2 | 1:2 |
| | Physical | Cutting resistance | 100 | 85 | 95 | 110 | 112 | 88 | 85 | 129 |
| | properties | Exothermicity | 100 | 110 | 105 | 99 | 100 | 105 | 110 | 90 |

| | | | Working Examples | | | | | | | |
|---|---|---|---|---|---|---|---|---|---|---|
| | | | 2 | 3 | 4 | 5 | 6 | 7 | 8 | 9 |
| Masterbatch | Parts | Natural rubber latex | 100 | 100 | 100 | 100 | 100 | 70 | 100 | 100 |
| | by mass | (dry rubber component) | | | | | | | | |
| | | CNF1 | 5 | 5 | 5 | 1 | 30 | 5 | — | — |
| | | CNF2 | — | — | — | — | — | — | 5 | 5 |
| | | Wet silica | — | — | — | — | — | — | — | — |
| | | Colloidal silica 1 | — | — | — | — | — | — | 10 | — |
| | | Colloidal silica 2 | 1 | 10 | 30 | 10 | 10 | 10 | — | 10 |
| Rubber | Parts | Masterbatch | 106 | 115 | 135 | 111 | 140 | 85 | 115 | 115 |
| composition | by mass | Solid natural rubber | — | — | — | — | — | — | — | — |
| | | CNF1 | — | — | — | — | — | — | — | — |
| | | Wet silica | — | — | — | — | — | — | — | — |
| | | Colloidal silica 2 | — | — | — | — | — | — | — | — |
| | | Carbon black | 5 | 5 | 5 | 5 | 5 | 5 | 5 | 5 |
| | | Butadiene rubber | — | — | — | — | — | 30 | — | — |
| | | Zinc oxide | 1 | 1 | 1 | 1 | 1 | 1 | 1 | 1 |
| | | Stearic acid | 2 | 2 | 2 | 2 | 2 | 2 | 2 | 2 |
| | | Antioxidant | 2 | 2 | 2 | 2 | 2 | 2 | 2 | 2 |
| | | Sulfur | 2 | 2 | 2 | 2 | 2 | 2 | 2 | 2 |
| | | Vulcanization accelerator | 1 | 1 | 1 | 1 | 1 | 1 | 1 | 1 |

| Mass ratio of cellulose nanofiber to silica | | 5:1 | 1:2 | 1:6 | 1:10 | 3:1 | 1:2 | 1:2 | 1:2 |
|---|---|---|---|---|---|---|---|---|---|
| Physical | Cutting resistance | 105 | 138 | 145 | 115 | 145 | 120 | 113 | 121 |
| properties | Exothermicity | 96 | 97 | 99 | 96 | 99 | 105 | 95 | 97 |

In this table, the amounts of CNF1 and CNF2 represent the net amounts of cellulose nanofibers but not the amounts of the cellulose nanofiber dispersions. The amount of colloidal silica also represents the net amount of silica but not the amount of the dispersion.

In the case of adopting a procedure in which natural rubber latex and colloidal silica were added to a cellulose nanofiber dispersion and then agitation was performed, the ability to achieve reduced heat generation and cutting resistance were superior compared to the case of adopting a procedure in which only natural rubber latex was added to a cellulose nanofiber dispersion and then agitation was performed (see Comparative Example 6 and Working Example 3).

In the case of adopting a procedure in which natural rubber latex and colloidal silica were added to a cellulose nanofiber dispersion and then agitation was performed, the ability to achieve reduced heat generation and cutting resistance were superior compared to the case of adopting a procedure in which only colloidal silica was added to natural rubber latex and then agitation was performed (see Comparative Example 5 and Working Example 3).

In the case of adopting a procedure in which natural rubber latex and colloidal silica were added to a cellulose nanofiber dispersion and then agitation was performed, the ability to achieve reduced heat generation and cutting resistance were superior compared to the case of adopting a procedure in which natural rubber latex and wet silica were added to a cellulose nanofiber dispersion and then agitation was performed (see Comparative Example 3 and Working Example 3).

What is claimed is:

1. A masterbatch manufacturing method comprising:
an operation in which at least a cellulose nanofiber dispersion, colloidal silica, and diene-based rubber latex are mixed to prepare a liquid mixture; and
an operation in which the liquid mixture is coagulated.

2. The masterbatch manufacturing method according to claim 1, wherein the colloidal silica has a particle size of 2 nm to 40 nm.

3. The masterbatch manufacturing method according to claim 1, wherein silica particles in the colloidal silica are 1 part by mass or more and 30 parts by mass or less per 100 parts by mass of a dry rubber component in the diene-based rubber latex in the operation in which the liquid mixture is prepared.

4. The masterbatch manufacturing method according to claim 1, wherein a fiber diameter of cellulose nanofibers in the cellulose nanofiber dispersion is 100 nm or less.

5. The masterbatch manufacturing method according to claim 1, wherein cellulose nanofibers in the cellulose nanofiber dispersion are 1 part by mass or more and 50 parts by mass or less per 100 parts by mass of a dry rubber component in the diene-based rubber latex in the operation in which the liquid mixture is prepared.

6. The masterbatch manufacturing method according to claim 1, wherein the diene-based rubber latex is natural rubber latex.

7. The masterbatch manufacturing method according to claim 1, further comprising an operation in which a coagulum obtained in the operation in which the liquid mixture is coagulated is dewatered.

8. The masterbatch manufacturing method according to claim 1, further comprising an operation in which a coagulum obtained in the operation in which the liquid mixture is coagulated is dewatered using an extruder.

9. The masterbatch manufacturing method according to claim 1, wherein the colloidal silica has a particle size of 30 nm or less.

10. The masterbatch manufacturing method according to claim 1, wherein the colloidal silica has a particle size of 20 nm or less.

11. The masterbatch manufacturing method according to claim 1, wherein silica particles in the colloidal silica are 3 parts by mass or more and 20 parts by mass or less per 100 parts by mass of a dry rubber component in the diene-based rubber latex in the operation in which the liquid mixture is prepared.

12. The masterbatch manufacturing method according to claim 1, wherein silica particles in the colloidal silica are 5 parts by mass or more and 15 parts by mass or less per 100 parts by mass of a dry rubber component in the diene-based rubber latex in the operation in which the liquid mixture is prepared.

13. The masterbatch manufacturing method according to claim 1, wherein cellulose nanofibers in the cellulose nanofiber dispersion are 3 parts by mass or more and 30 parts by mass or less per 100 parts by mass of a dry rubber component in the diene-based rubber latex in the operation in which the liquid mixture is prepared.

14. The masterbatch manufacturing method according to claim 1, wherein cellulose nanofibers in the cellulose nanofiber dispersion are 5 parts by mass or more and 30 parts by mass or less per 100 parts by mass of a dry rubber component in the diene-based rubber latex in the operation in which the liquid mixture is prepared.

15. The masterbatch manufacturing method according to claim 1, wherein cellulose nanofibers in the cellulose nanofiber dispersion are 5 parts by mass or more and 20 parts by mass or less per 100 parts by mass of a dry rubber component in the diene-based rubber latex in the operation in which the liquid mixture is prepared.

16. A method for manufacturing a rubber composition for tire, the method comprising:
an operation in which a masterbatch is prepared by the masterbatch manufacturing method according to claim 1; and
an operation in which the masterbatch is used to prepare a rubber composition.

17. The method for manufacturing a rubber composition for tire according to claim 16, wherein the operation in which the rubber composition is prepared includes kneading at least the masterbatch and a compounding ingredient to prepare a rubber mixture and kneading at least the rubber mixture and sulfur to obtain a rubber composition.

18. A tire manufacturing method comprising:
an operation in which a masterbatch is prepared by the masterbatch manufacturing method according to claim 1;
an operation in which the masterbatch is used to prepare a rubber composition; and
an operation in which the rubber composition is used to prepare an unvulcanized tire.

19. The tire manufacturing method according to claim 18, wherein the operation in which the unvulcanized tire is prepared includes preparing a tire member containing the rubber composition and preparing the unvulcanized tire containing the tire member.

20. The tire manufacturing method according to claim 18, further comprising an operation in which the unvulcanized tire is vulcanized and molded.
